(19) United States
(12) Patent Application Publication
(10) Pub. No.: US 2007/0067192 A1
(43) Pub. Date: Mar. 22, 2007

(54) System and method for providing transferable pre-need funeral services

(76) Inventor: Vanessa Sutton, Atlanta, GA (US)

Correspondence Address: MYERS & KAPLAN, INTELLECTUAL PROPERTY LAW, L.L.C., 1899 POWERS FERRY ROAD, SUITE 310, ATLANTA, GA, 30339, US

(21) Appl. No.: 11/492,724

(22) Filed: Jul. 25, 2006

Related U.S. Application Data
(60) Provisional application No. 60/703,138, filed on Jul. 28, 2005.

(51) Int. Cl. G06Q 99/00; G06Q 40/00

(52) U.S. Cl. 705/4; 705/1

(57) ABSTRACT

A system and method for providing pre-need funeral services that enables a consumer to select a funeral plan and servicing funeral home, within a desired budget, through a website service or associated telephonic system. Following subscription to a service plan, the consumer will be provided with a debit card or SMART card technology from which funeral plan payments may be made, and through which access to the funeral plan may be provided. The present system seeks to maintain a database of all purchased funeral plans and arrangements, so as to facilitate consumer requests for modification to, and/or updating of, existing polices, wherein such modifications will be readily available through the SMART card technology.

Priority based on U.S. Provisional Patent Application Ser. No. 60/703,138, filed Jul. 28, 2005, and entitled, “System and Method for Providing Transferable Pre-Need Funeral Services”, is claimed.

### TECHNICAL FIELD

The present invention relates generally to funeral planning services, and more specifically to a system and method for providing transferable pre-need funeral services, wherein the present system and method provides, amongst other features, smart card technology for the storage and unrestricted instant access of funeral and insurance policy information by the policy holder, agent and/or named-beneficiaries; thus, avoiding the confusion and inconveniences associated with requesting the policy provider to release such information during time of need (i.e., policy holder's death).

### BACKGROUND OF THE INVENTION

Owners and managers of funeral homes are concerned with the future of their firm's profitability and revenue generating techniques, whilst maintaining compassion and professionalism for the families they serve. Indeed, the funeral industry was different some years ago, as the general public would have to purchase caskets and related products through a funeral home. Now, due to public policy changes and industry deregulation, the public may purchase caskets directly from casket manufacturers or retailers; thus, significantly cutting into the profit margin of the funeral home.

In an attempt to increase overall firm profitability, and satiate the demands of the consuming public, all within an extremely competitive industry, many funeral homes now offer pre-need funeral plans in an attempt to capture and maintain consumer loyalty. Such pre-need offerings provide consumers with the ability to purchase a funeral plan or arrangement prior to death. Unfortunately, the operational complexities and marketing costs associated with current pre-need offerings tend to dissuade or discourage funeral homes from providing such services. That is, many current pre-need services require significant consumer and funeral home face-to-face interaction, which absorbs funeral home resources and man-hours, and unfavorably imposes overly complex, and often onerous, transactional duties and obligations upon the consumer (i.e., lengthy and legally-complex contracts); thus, discouraging the consumer from subscribing to such pre-need services. Additionally, the funeral plans offered through various current pre-need services differ only minimally in cost, and thus, do not necessarily provide an ongoing incentive for families to utilize the same funeral home for future services, as opposed to another local funeral home.

Additionally, other pre-need service companies take a consumer advocate approach, in that they negotiate funeral expenses and arrangements on behalf of the consumer with a selected pool or group of funeral homes, seeking the best financial deal within set price ranges or plans. Unfortunately, such an approach results in a number of disadvantages, including causing a bidding war amongst competing funeral homes (i.e., price undercutting amongst funeral homes for trivial amounts); devaluation of services; potential impersonalization of funeral arrangements (i.e., a “cookie-cutter” funeral service); and, a move away from the preferred compassionate and professional atmosphere toward a more impersonal, strictly business-centered atmosphere, and thus, a decline in overall consumer loyalty and future business.

As a further concern, many pre-need insurance companies and general life insurance companies impose burdensome privacy polices that make it exceedingly difficult for a family and/or named-beneficiary to retrieve or request the release of the deceased's pre-need funeral plan/arrangement information; thus, detracting from the standard of compassion and professionalism of the servicing funeral home or insurance company. Such privacy polices become even more onerous when the pre-need or insurance policy has been misplaced, is lost, or has otherwise become inaccessible.

Therefore, it is readily apparent that there is a need for a system and method for providing pre-need funeral plans and services that may be expeditiously subscribed to and implemented; that may be subscribed to via telephone or global networking system services (i.e., remotely); that requires minimal funeral home resources and man-hours; that maintains the desired standard of compassion and professionalism of the servicing funeral home, whilst increasing profits; that avoids a consumer-advocate approach, yet enables consumer freedom in the selection of a desired funeral home and plan; that avoids bidding wars amongst competing funeral homes; that maintains the integrity and value of provided funeral services; that promotes consumer personalization and selection of funeral arrangements; and, that disposes of unnecessarily burdensome privacy policies encountered in obtaining the policy information of the recently deceased.

### BRIEF SUMMARY OF THE INVENTION

Briefly described, in a preferred embodiment, the present invention overcomes the above-mentioned disadvantages, and meets the recognized need for such an invention by providing a system and method for providing pre-need funeral plans and services that enables online or telephonic selection of a specific funeral plan and servicing funeral home, within a desired budget. Debit card or SMART card technology is utilized to implement various aspects of the selected service, including access to the pre-need policy, payment processes, and modifications to the policy.

According to its major aspects and broadly stated, the present invention in its preferred form is a system and method for providing pre-need funeral plans and services, comprising an online application and funeral plan/home selection process, funeral plan/home database, telephonic subscription and counseling services, policy issuance process, debit/SMART card issuance process, policy retrieval and access services, death certificate processing services, pre-need counseling services, funeral plan implementation services, and “transfer of remains” services.

More specifically, the present invention is a system and method for providing pre-need funeral plans and services, wherein consumers may access a website service and purchase a funeral plan, detailing a desired memorial service (i.e., burial, cremation, etc.) and a desired funeral home, all within the consumer's budget. Following subscription to a service plan, the consumer will be provided with a debit card or SMART card from which funeral plan payments may be made, and through which access to the funeral plan may be provided. The present system seeks to maintain a database of all purchased funeral plans and arrangements, so as to facilitate consumer requests for modification to, and/or updating of, existing polices, wherein such modifications will be made in real-time and readily available through SMART card technology. The SMART card technology of the present invention is further made available for storing and accessing general life insurance policy information.

During time-of-death, the debit/SMART card technology of the present invention seeks to facilitate funeral arrangements for the deceased by making the policy specifications readily available to the deceased's family, named-beneficiary, agent, and/or servicing funeral home. That is, because the card may simply be carried in the policy holder's wallet or purse, or placed in another secure location, should the policy holder die, family members may simply retrieve the card from the wallet, purse or secure location, and thereafter access and retrieve the requisite information; thus, avoiding the confusion and inconveniences associated with requesting the policy provider to release such information during time of need (i.e., policy holder's death).

The present system further offers a 24-hour, 7-days-a-week call-center through which telephonic subscription and counseling services for a specific funeral plan may be provided, and through which general pre-need counseling services may be offered. Subscription to certain policies further provides “transfer of remains” services through which the deceased will be transferred from place of death to the selected funeral home. Still other services offer processing of death certificates and grief counseling.

The present invention still further offers general life insurance policies and programs in conjunction with the pre-need funeral services. Additionally, a Social Security module of the present invention enables consumers to pay into Social Security funds for subsequent application or assignment toward their pre-selected funeral services. Similar such modules are offered through the present system and method for funding transferable pension plans, transferable educational funds, and/or other transferable trust funds and accounts. A pre-need insurance rider will further be offered for long-term health care plans and veteran plans.

In general, in one aspect, the invention features a method for providing pre-need funeral services, including identifying a pre-need customer, providing the pre-need customer access to a pre-need system, providing pre-need policy information to the pre-need customer via the pre-need system, determining payment for the pre-need policy and determining pre-need policy commitment by the pre-need customer.

In one implementation, the method further includes identifying a pre-need customer comprises determining whether the pre-need customer is an existing customer.

In another implementation, identifying a pre-need customer comprises determining whether the pre-need customer is interested in a pre-need policy.

In another implementation, the method further includes activating a pre-need account.

In another implementation, the method further includes activating a pre-need payment card.

In another implementation, the pre-need payment card is a debit card.

In another implementation, the pre-need payment card is a smart card.

In another implementation, the method further includes providing a combination kit to the pre-need customer.

In another implementation, the combination kit includes the pre-need policy and the pre-need payment card for use in conjunction with activities related to the pre-need policy.

In yet another implementation, the activities related to the pre-need policy comprise purchasing funeral services.

In still another implementation, the activities related to the pre-need policy comprise purchasing funeral merchandise.

In another implementation, the activities related to the pre-need policy comprise purchasing insurance.

In another implementation, the method further includes collecting demographic data related to the pre-need customer.

In another implementation, the demographic date includes personal information related to the pre-need customer's preferences for funeral arrangements.

In another implementation, the demographic data includes beneficiary information.

In another implementation, a named beneficiary receives a remaining balance once pre-need services are complete upon the death of the pre-need customer.

In another implementation, the demographic data includes living will information.

In another implementation, the method further includes identifying an insurance policy to be used for funding the pre-need policy.

In another implementation, the method further includes executing an assignment of benefits related to the insurance policy to fund the pre-need policy.

In another aspect, the invention features a system for providing pre-need funeral services, including a pre-need funeral and insurance service provider to provide a pre-need policy and insurance, a pre-need policy service funded by an assignment of the insurance provided by the insurance provider, a pre-need package service combining the pre-need policy and the insurance, a funeral home service to be funded by the pre-need policy upon death of a pre-need policy holder and a merchandise service to be funded by the pre-need policy upon death of a pre-need policy holder.

In one implementation, the system further includes patient/policy holder search service and database for identifying services related to the pre-need policy.

In another implementation, the system further includes an educational service to provide updated information related to the pre-need policy.

In another implementation, the system further includes a consumer service for providing the pre-need policy-holder consumer services related to the pre-need policy.

In another implementation, the system further includes a payment service for payment of the pre-need policy.

In another implementation, the payment service comprises providing a payment card to the policy-holder for payment of related per-need services.

In another implementation, the payment card comprises SMART card technology from which funeral plan payments may be made, and through which access to the funeral plan may be provided.

In still another implementation, the payment card is a debit card.

In yet another implementation, the system further includes a certified pre-need insurance agent for providing an insurance policy, the benefits of which are assigned to fund the pre-need policy.

In another implementation, the system further includes a service website that the policy holder can access pre-need services related to the pre-need policy.

In another implementation, the system further includes a system administrator for oversight of all the pre-need policy services.

In another aspect, the invention features a system, including a pre-need website, a customer service center coupled to the pre-need website, a customer portal to the pre-need website and an administrator portal to the pre-need website.

In one implementation, the system further includes a funeral services provider portal to the pre-need website.

In another implementation, the system further includes an insurance agent portal to the pre-need website.

In another implementation, the system further includes means for directing insurance policy proceeds for use as payment for a pre-need policy.

In another implementation, the pre-need website provides access to educational services.

In another aspect, the invention features a method, including choosing desired funeral arrangements, identifying a payment plan for the funeral arrangements and identifying a beneficiary to receive an overage of funding for the funeral arrangements.

In one implementation, the payment plan is the assignment of life insurance proceeds.

In another implementation, the payment plan is the activation of a pre-need debit card.

In another implementation, the payment plan is the activation of a pre-need smart card.

In another implementation, the funeral arrangements are funeral services.

In another implementation, the funeral arrangements are funeral merchandise.

In another implementation, the method further includes choosing a funeral director for making the funeral arrangements.

In another implementation, the method further includes choosing an insurance agent.

In another implementation, the method further includes obtaining a pre-need policy.

In another implementation, the method further includes obtaining an insurance policy.

In another implementation, the method further includes assigning proceeds associated with the insurance policy to the payment of the pre-need policy.

Accordingly, a feature and advantage of the present invention is its ability to provide an online application for pre-need planning services, including selection of a desired funeral plan and funeral home.

Another feature and advantage of the present invention is its ability to provide a database of funeral homes and associated funeral services.

Still another feature and advantage of the present invention is its ability to provide a 24-hour, 7-days-a-week call-center for pre-need subscription and counseling services.

Yet another feature and advantage of the present invention is its ability to provide SMART card technology for the storage and unrestricted instant access of funeral plans and insurance policy information by the policy holder, named-beneficiaries and/or servicing funeral home; thus, avoiding the confusion and inconveniences associated with requesting the policy provider/agent to release such information during time of need (i.e., policy holder's death).

Still yet another feature and advantage of the present invention is its ability to provide SMART card technology to facilitate expeditious implementation of the pre-selected funeral plan and service.

These and other features and advantages of the invention will become more apparent to one skilled in the art from the following description and claims when read in light of the accompanying drawings.

### BRIEF DESCRIPTION OF THE DRAWINGS

The present invention will be better understood by reading the Detailed Description of the Preferred and Alternate Embodiments with reference to the accompanying drawing figures, in which like reference numerals denote similar structure and refer to like elements throughout, and in which:

FIG. 1 is a system level flow diagram of a system and method for providing pre-need funeral services;

FIG. 2 is a flow diagram of a demographic information collection system and method for providing pre-need funeral services;

FIG. 3 is a flow diagram of a system and method for providing pre-need funeral services;

FIG. 4 is a flow diagram of a system and method for providing pre-need funeral services;

FIG. 5 is a flow diagram of a system and method for providing pre-need funeral services;

FIG. 6 is a system level and flow diagram of a system and method for providing pre-need funeral services;

FIG. 7 is an embodiment of a pre-need enrollment form; and

FIG. 8 is another embodiment of a pre-need enrollment form.

### DETAILED DESCRIPTION OF THE PREFERRED AND ALTERNATIVE EMBODIMENTS

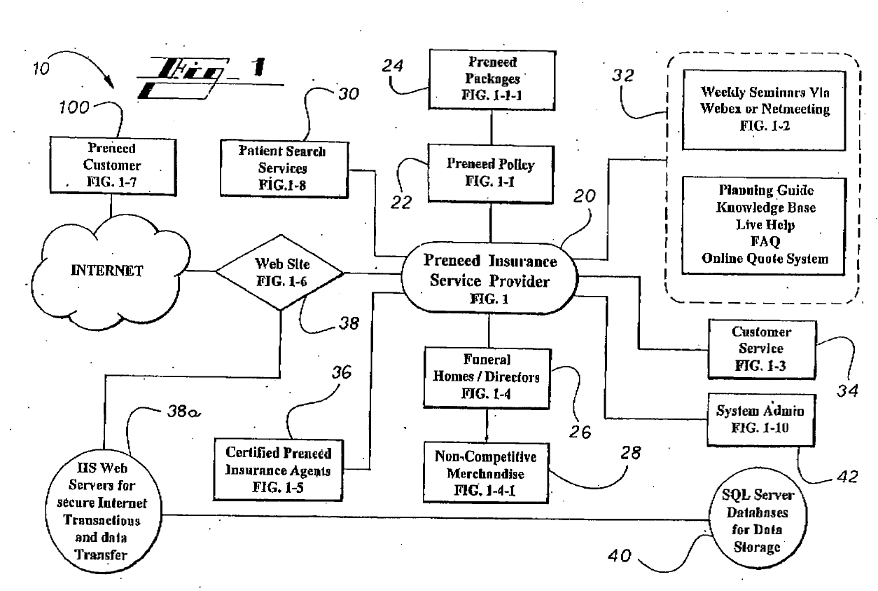

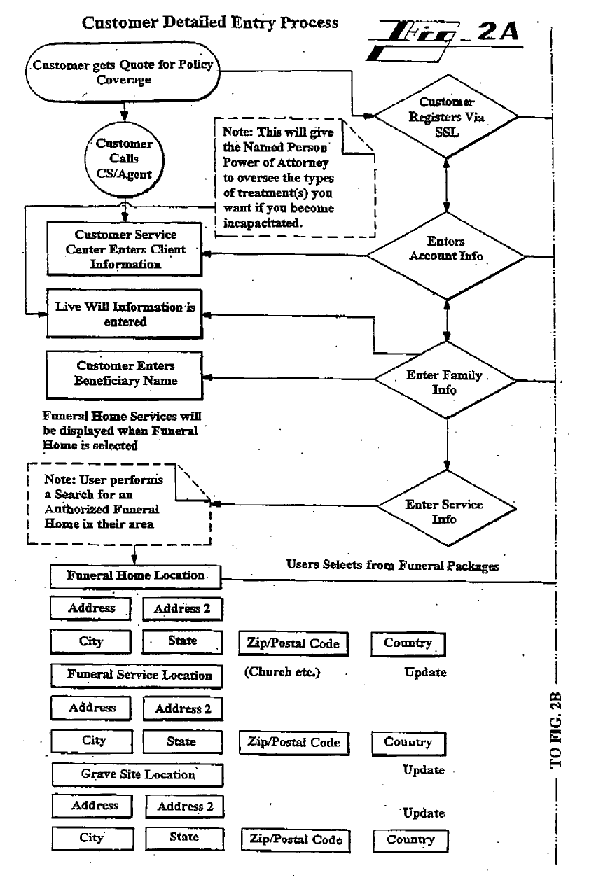

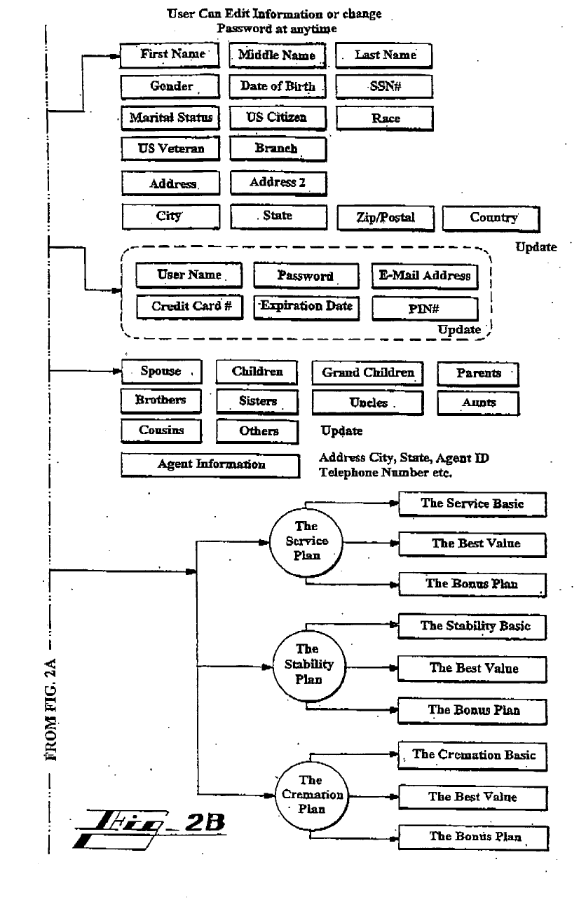

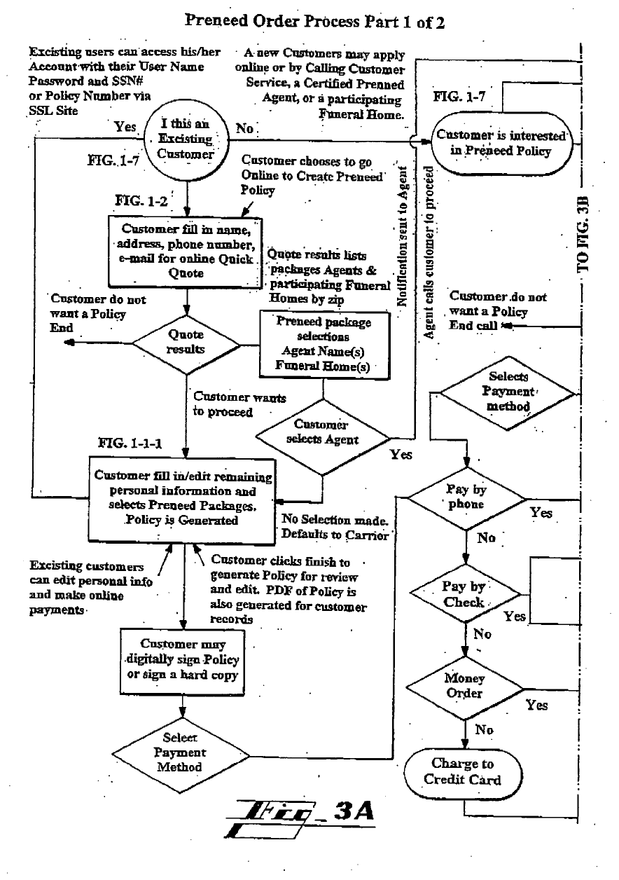

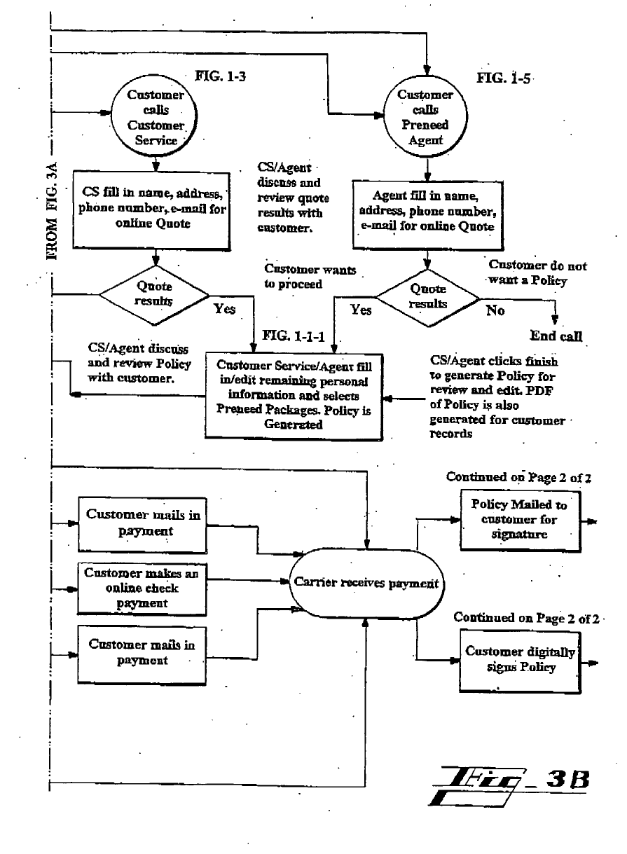

In describing the preferred and alternate embodiments of the present invention, as illustrated in FIGS. 1-6, specific terminology is employed for the sake of clarity. The invention, however, is not intended to be limited to the specific terminology so selected, and it is to be understood that each specific element includes all technical equivalents that operate in a similar manner to accomplish similar functions.

The systems and methods described herein can be implemented to create, market, manage and use information related to pre-need insurance sales. The systems and methods can enhance delivery of individual pre-need insurance policies to an individual policy holder and sales agent. Large amounts of data can be received regarding individual pre-need funeral sales associated with a servicing a funeral home and consumer. Data is analyzed and pre-funded with various insurance products, such as individual whole life insurance with a servicing funeral home for a retail value of a funeral. Products can include long term care insurance with a pre-need contract plan rider social security administration clients pre-need contract plan rider, which funeral benefits depend on the paid contributions of the policy holder and other federal agencies that fit the criteria for paid contributions. Data is analyzed and amounts are calculated and pre-funded with various insurance products in light of known adverse events associated with the product. A proprietary database of newly discovered adverse event information can be created and utilized, and new characteristics of or uses for the delivery of product are determined. Adverse event information is gathered for a large number of population sub-groups. The system can also be programmed to incorporate the information into contract documents. Marketers and or distributors can include the proprietary information in the customer information, which is provided to the customer. In the case of certain insurance products or devices, information can be provided to issuers of those products or devices.

Referring generally now to FIG. 1, the present invention in its preferred embodiment is a system and method 10 for providing pre-need funeral services, wherein the present invention comprises a pre-need funeral and insurance service provider 20, wherein service provider 20 provides access to pre-need policy service 22, pre-need package service 24, funeral homes/directors services 26, non-competitive merchandise 28, patient/policy holder search services and databases 30, educational services 32, customer services 34, certified pre-need insurance agents 36, and service website 38 through which electronic transactions and data transfer 38a is initiated, and through which database 40 may be accessed. Service provider 20 may access database 40 via system administrator 42. Preferably service website 38 and database 40 may be accessed by pre-need consumer 100 via a global networking system (e.g., Internet).

Referring now more specifically to FIG. 2, consumer 100 preferably subscribes to pre-need policies 22 and pre-need packages 24 via website 38 or calling consumer service 34. In either instance, consumer 100 preferably subscribes to pre-need services 22, 24 by providing personal information, such as, for exemplary purposes only, full legal name, gender, date of birth, social security number, marital status, residency and/or citizenship, race, full legal address, will and trust information, named beneficiary information, information pertaining to immediate family members, and the like. In subscribing to pre-need services 22, 24, consumer 100 is provided with a user account through which consumer 100 may access databases 40 for future retrieval of subscribed pre-need services 22, 24. User account preferably comprises, and may be accessed via entering, username, password, email address, and/or pin numbers, and may further be utilized to enter credit card information for payment of pre-need services 22, 24. Additionally, the user account may also be accessed via secure credentials provided through a SMART card interface, or the like.

Through consumer service 34 or website 38, consumer 100 may further explore and select servicing funeral homes/directors 26, merchandise 28, and educational materials 32 offered under pre-need services 22, 24. Specifically, through funeral homes/directors services 26, consumer 100 may select the specific funeral home location, funeral service location and/or gravesite location, where consumer 100 wishes for his/her remains to be transferred. Furthermore, through merchandise services 28, consumer may select the desired funeral arrangements and accessories (i.e., floral arrangements, casket type, etc.). With specific regard to pre-need packages 24, consumer may select from an array of service plans under which various service options are provided.

Referring now more specifically to FIG. 3, with continued reference to FIGS. 1-2, all information entered through website 38, and/or provided to certified pre-need insurance agents 36 via consumer service 34, may be modified or otherwise changed by consumer 100 at consumer's election. Additionally, through website 38 or consumer service 34, consumer 100 may effectuate payment for services 22, 24, wherein credit/debit/SMART card payment information may be supplied via online transactions 38a, or via telephonic transaction with certified pre-need insurance agent 36. Upon payment for the subscribed services 22, 24, consumer 100 is electronically mailed, and hard-mailed, a copy of the pre-need policy and plan.

In general, it is first determined whether or not the customer is an existing customer. If the customer is not existing, then demographic information can be collected and a quote for a pre-need policy provided. Pre-need policies and packages are presented to the customer and the customer is further provided with lists of agents, funeral homes, funeral directors, funeral merchandise vendors and the like. Payment plans are identified and executed as discussed further below. New customer can typically apply over a network, by telephone, through a certified pre-need agent, a participating funeral home and the like.

If the customer is an existing customer, then the customer can modify the pre-need policies and packages as desired. Existing customer can typically access his/her account with a user name, password, social security number, policy number and the like.

Referring now more specifically to FIG. 4, with continued reference to FIGS. 1-3, upon receipt of the pre-need policy and plan, consumer 100 may digitally sign the electronic version of the policy and/or sign the hard copy of the policy, and forward same to service provider 20 for account activation. Upon receipt of the signed and executed pre-need policy/plan, service provider 20 performs a fraud check prior to activating consumer's 100 account, wherein satisfaction of the fraud check and implementation of consumer's 100 account, preferably results in consumer 100 being issued debit cards and/or SMART cards for account access and policy/plan retrieval. Accordingly, consumer 100 may utilize the issued debit card or SMART card to effectuate any subsequent fees or payments incurred in plan/policy changes and/or to access such existing or modified policies/plans. Moreover, inherent in the SMART card technology is the ability for consumer 100 to receive real-time or immediate confirmation of updated or modified policies, and to act on such policies; thereby, facilitating a paperless pre-need service process. The SMART card technology of the present invention is further made available for storing and accessing general life insurance policy information; thereby, facilitating a paperless general life insurance policy process.

Additionally, the issued debit/SMART card facilitates funeral arrangements for the deceased/consumer 100 by making the policy and plan specifications readily available to consumer's 100 family, named beneficiary, and/or servicing funeral home, as selected or otherwise designated during initial ordering or subscription to pre-need services 22, 24, as may be subsequently modified from time-to-time in accordance with the disclosure provided hereinabove.

Debit/smart cards can also be used for medical emergencies and is reproduced on wallet-sized identification cards containing individual vital and medical information for use by medical personnel. The cards can also contain final arrangements and be kept on record at mortuaries.

In a typical embodiment, when a debit card is issued, the account holder selects a personal identification number (PIN) that is used when the card is processed. Entering a PIN helps ensure that all of the accepted transactions are secured. Signatures and identification are typically not required when accepting debit cards. With direct access to major debit networks, debit card acceptance is easy regardless of location. The PIN is not kept on the card, but rather in an encrypted database. Typically a PIN is encrypted when used, and sent to and compared within the database. Encrypted forms of the PIN can reside in a database or on the card itself. In a typical implementation, one-way cryptography is used to compute a cipher given to an institution's key and the customer's PIN. It is typically not computationally feasible to obtain the plain text PIN from the cipher, even if a fraudulent user has the key.

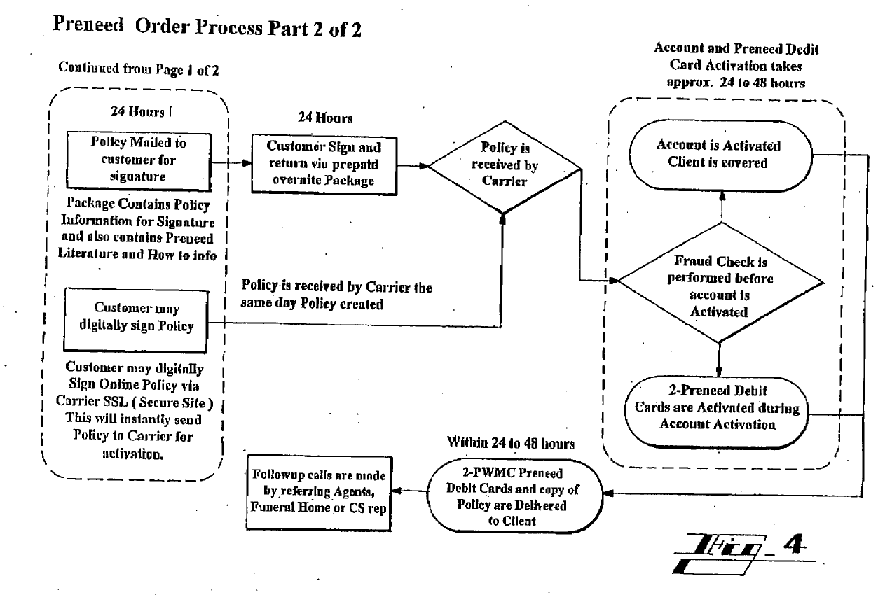

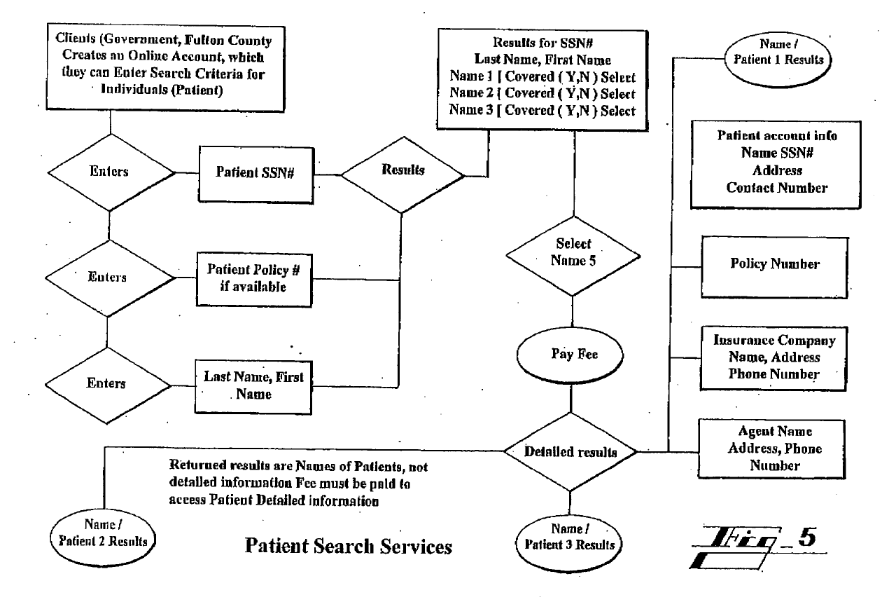

Referring now more specifically to FIG. 5, patient/policy search services 30 enables service provider 20, consumer 100 and other authorized individuals (i.e., government officials and agents) to access pre-need policy/plan information of consumer 100 to facilitate management and determination of funeral services and arrangements at time-of-death of consumer 100. Patient/policy search services 30 may be accessed via website 38 and/or database 40 upon entry of specific patient/consumer 100 information, such as, for exemplary purposes only, Social Security Number, policy/plan number, and/or personal information about consumer 100, wherein detailed results will be provided upon proper authorized entry.

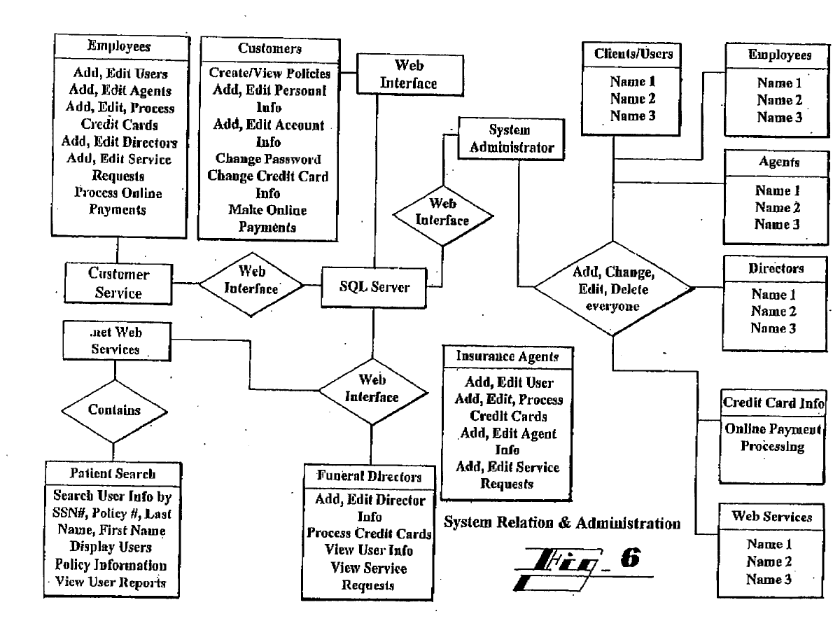

Referring now more specifically to FIG. 6, service provider 20 may access database 40 via system administrator 42, wherein system administrator 42 enables service provider 20 to manage all aspects relevant to consumer's 100 specific pre-need service 22, 24. Such management includes viewing, emailing and printing policy or ID cards, checking billing status and online payments, viewing account activity, viewing detailed coverage information, checking claim status, adding or deleting users, beneficiaries, agents, representatives and/or directors, altering provider services, and processing payments.

In general, system 10 can include several security layers that can be changed per each customer. Customers are typically assigned separate logins and passwords. Customers can view, use email, print policies and identification cards, check billing status and make online payments, view account activity, view detailed coverage information, and check claim status. At an administration level, the administrator can create view, use email, print policies and identification cards related to a customer, check billing status and make online payments for a customer, view account activity for a customer, view detailed coverage information for a customer, and check claim status for a customer. Administrators can also add or delete users, agents, representative and directors. Customer service representatives can further create, view, use email, print policies and identification cards related to a customer, check billing status and make online payments for a customer, view account activity for a customer, view detailed coverage information for a customer, and check claim status for a customer.

As discussed above, agents and directors can also have access to the system. Specifically agents and directors, or other related certified services providers can view, use email, print policies and identification cards related to a customer, check billing status and make online payments for a customer, view account activity for a customer, view detailed coverage information for a customer, and check claim status for a customer.

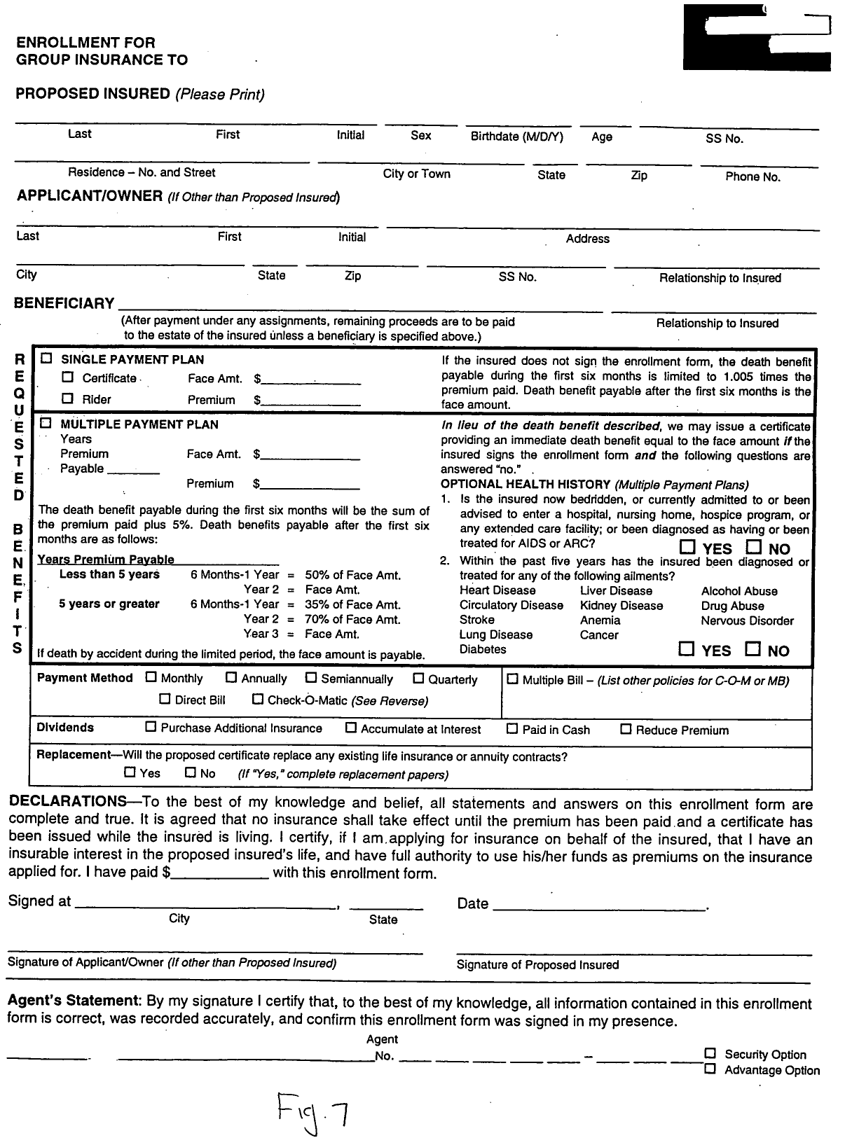

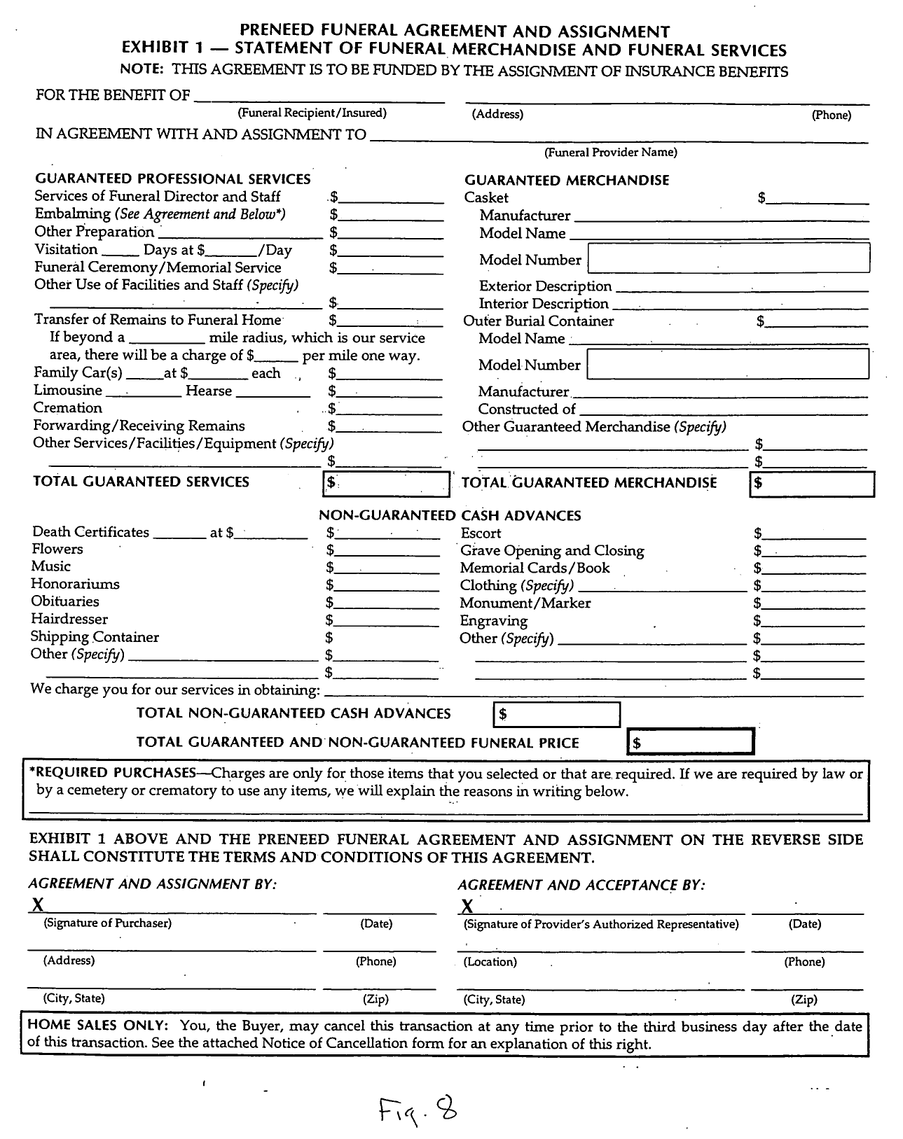

FIGS. 7 and 8 are embodiments of a pre-need enrollment forms.

The present invention still further offers general life insurance policies and programs in conjunction with the pre-need funeral services. Additionally, a Social Security module of the present invention enables consumers 100 to pay into Social Security funds for subsequent application, assignment or disbursement toward their pre-selected funeral servicing home. Still other modules of the present invention offer payment into education funds and/or pension funds, as well as trust accounts, all of which may be subsequently transferred, conveyed, assigned or otherwise applied to a named-beneficiary, or further made available for implementation of the selected funeral service. A pre-need insurance rider will further be offered for long-term health care plans and veteran plans.

The software techniques and methods discussed above can be implemented in digital electronic circuitry, or in computer hardware, firmware (as discussed), software, or in combinations of them. Apparatus may be implemented in a computer program product tangibly embodied in a machine-readable storage device for execution by a programmable processor; and methods may be performed by a programmable processor executing a program of instructions to perform functions by operating on input data and generating output. Further embodiments may advantageously be implemented in one or more computer programs that are executable on a programmable system including at least one programmable processor coupled to receive data and instructions from, and transmit data and instructions, to a data storage system, at least one input device, and at least one output device. Each computer program may be implemented in machine language or assembly language which can be assembled or translated, or a high level procedural or object-oriented programming language, which can be complied or interpreted. Suitable processors include, by way of example, both general and special purpose microprocessors. Generally, a processor receives instructions and data from read-only memory and or RAM. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing may be supplemented by, or incorporated in, specially designed application specific integrated circuits (ASICs).

Having thus described exemplary embodiments of the present invention, it should be noted by those skilled in the art that the within disclosures are exemplary only, and that various other alternatives, adaptations, and modifications may be made within the scope of the present invention. Accordingly, the present invention is not limited to the specific embodiments illustrated herein, but is limited only by the following claims.

What is claimed is:

1. A method for providing pre-need funeral services, comprising:
identifying a pre-need customer;
providing the pre-need customer access to a pre-need system;
providing pre-need policy information to the pre-need customer via the pre-need system;
determining payment for the pre-need policy; and
determining pre-need policy commitment by the pre-need customer.

2. The method as claimed in claim 1 wherein identifying a pre-need customer comprises determining whether the pre-need customer is an existing customer.

3. The method as claimed in claim 1 wherein identifying a pre-need customer comprises determining whether the pre-need customer is interested in a pre-need policy.

4. The method as claimed in claim 1 further comprising activating a pre-need account.

5. The method as claimed in claim 4 further comprising activating a pre-need payment card.

6. The method as claimed in claim 5 wherein the pre-need payment card is a debit card.

7. The method as claimed in claim 5 wherein the pre-need payment card is a smart card.

8. The method as claimed in claim 5 further comprising providing a combination kit to the pre-need customer.

9. The method as claimed in claim 8 wherein the combination kit comprises:
the pre-need policy; and
the pre-need payment card for use in conjunction with activities related to the pre-need policy.

10. The method as claimed in claim 9 wherein the activities related to the pre-need policy comprise purchasing funeral services.

11. The method as claimed in claim 9 wherein the activities related to the pre-need policy comprise purchasing funeral merchandise.

12. The method as claimed in claim 9 wherein the activities related to the pre-need policy comprise purchasing insurance.

13. The method as claimed in claim 1 further comprising collecting demographic data related to the pre-need customer.

14. The method as claimed in claim 13 wherein the demographic date includes personal information related to the pre-need customer's preferences for funeral arrangements.

15. The method as claimed in claim 13 wherein the demographic data includes beneficiary information.

16. The method as claimed in claim 15 wherein a named beneficiary receives a remaining balance once pre-need services are complete upon the death of the pre-need customer.

17. The method as claimed in claim 13 wherein the demographic data includes living will information.

18. The method as claimed in claim 1 further comprising identifying an insurance policy to be used for funding the pre-need policy.

19. The method as claimed in claim 18 further comprising executing an assignment of benefits related to the insurance policy to fund the pre-need policy.

20. A system for providing pre-need funeral services, comprising:
a pre-need funeral and insurance service provider to provide a pre-need policy and insurance;
a pre-need policy service funded by an assignment of the insurance provided by the insurance provider;
a pre-need package service combining the pre-need policy and the insurance;
a funeral home service to be funded by the pre-need policy upon death of a pre-need policy holder; and
a merchandise service to be funded by the pre-need policy upon death of a pre-need policy holder.

21. The system as claimed in claim 20 further comprising a patient/policy holder search service and database for identifying services related to the pre-need policy.

22. The system as claimed in claim 20 further comprising an educational service to provide updated information related to the pre-need policy.

23. The system as claimed in claim 20 further comprising a consumer service for providing the pre-need policy-holder consumer services related to the pre-need policy.

24. The method as claimed in claim 20 further comprising a payment service for payment of the pre-need policy.

25. The system as claimed in claim 24 wherein the payment service comprises providing a payment card to the policy-holder for payment of related per-need services.

26. The system as claimed in claim 25 wherein the payment card comprises SMART card technology from which funeral plan payments may be made, and through which access to the funeral plan may be provided.

27. The system as claimed in claim 25 wherein the payment card is a debit card.

28. The system as claimed in claim 24 further comprising a certified pre-need insurance agent for providing an insurance policy, the benefits of which are assigned to fund the pre-need policy.

29. The system as claimed in claim 20 further comprising a service website that the policy holder can access pre-need services related to the pre-need policy.

30. The system as claimed in claim 20 further comprising a system administrator for oversight of all the pre-need policy services.

31. A system, comprising:
a pre-need website;
a customer service center coupled to the pre-need website;
a customer portal to the pre-need website; and
an administrator portal to the pre-need website.

32. The system as claimed in claim 31 further comprising a funeral services provider portal to the pre-need website.

33. The system as claimed in claim 32 further comprising an insurance agent portal to the pre-need website.

34. The system as claimed in claim 33 further comprising means for directing insurance policy proceeds for use as payment for a pre-need policy.

35. The system as claimed in claim 31 wherein the pre-need website provides access to educational services.

36. A method, comprising:
choosing desired funeral arrangements;
identifying a payment plan for the funeral arrangements; and
identifying a beneficiary to receive an overage of funding for the funeral arrangements.

37. The method as claimed in claim 36 wherein the payment plan is the assignment of life insurance proceeds.

38. The method as claimed in claim 36 wherein the payment plan is the activation of a pre-need debit card.

39. The method as claimed in claim 36 wherein the payment plan is the activation of a pre-need smart card.

40. The method as claimed in claim 36 wherein the funeral arrangements are funeral services.

41. The method as claimed in claim 36 wherein the funeral arrangements are funeral merchandise.

42. The method as claimed in claim 36 further comprising choosing a funeral director for making the funeral arrangements.

43. The method as claimed in claim 42 further comprising choosing an insurance agent.

44. The method as claimed in claim 43 further comprising obtaining a pre-need policy.

45. The method as claimed in as claimed in claim 44 further comprising obtaining an insurance policy.

46. The method as claimed in claim 45 further comprising assigning proceeds associated with the insurance policy to the payment of the pre-need policy.
